(19) United States
(12) Patent Application Publication
(10) Pub. No.: US 2020/0143043 A1
(43) Pub. Date: May 7, 2020

(54) EDGE VERIFICATION AND ELIMINATION CONTROL FLOW INTEGRITY

(71) Applicant: Raytheon Company, Waltham, MA (US)

(72) Inventors: Patrick W. Hong, Redondo Beach, CA (US); Ben Luc, Cerritos, CA (US)

(21) Appl. No.: 16/183,218

(22) Filed: Nov. 7, 2018

(51) Int. Cl. G06F 21/54; G06F 21/57; G06F 21/56

(52) U.S. Cl. CPC G06F 21/54; G06F 21/566; G06F 21/577

(57) ABSTRACT

A method can include identifying, based on a control flow analysis and data flow analysis, an entry point of each of a plurality of functions of an application, the entry points including one or more forward edge entry points and one or more backward edge entry points for each function of the functions, generating a whitelist for each function, the whitelist including the identified entry points, and adding instructions to the application to include a whitelist check at the entry points to each of the functions.

### GOVERNMENT LICENSE RIGHTS

This invention was made with government support. The government has certain rights in the invention.

### TECHNICAL FIELD

Embodiments discussed herein regard devices, systems, and methods for cyber security. Some embodiments include control flow integrity by edge verification and elimination, shadow verification, or a combination thereof.

### BACKGROUND

Cyber intrusion and methods for detecting and preventing cyberattacks are a current hot issue in the world of computing. As systems become more interconnected, the opportunities for cyberattack and resulting payoff for successful cyberattacks are increasing.

To execute code reuse attacks, such as Return Oriented Programming (ROP), Jump Oriented Programming (JOP), or Counterfeit Object-Oriented Programming (COOP), an attacker often diverts the execution of a program to the code of the attacker's choice.

Code reuse attacks are a common cyberattack technique that re-purpose existing code segments in the code base. An attacker creates functional “gadgets” out of the existing code base and generally execute chains of gadgets to achieve their malicious goal. To execute a code-reuse attack, an attacker most often diverts the expected, normal execution, also known as control flow, of a program. The program is diverted to execute code of the attacker's choosing. Verifying or preventing control flow from being redirected has been termed control flow integrity (CFI). Two common, widely available CFI techniques include, Clang/LLVM and Microsoft Control Flow Guard (CFG), from Microsoft Corporation of Redmond Wash., United States. Clang/LLVM and Microsoft CFG perform CFI on the forward edge or use shadow stacks for the backward edge.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments or examples discussed in the present document.

FIG. 1 illustrates, by way of example, a diagram of whitelists with different granularities.

FIG. 2 illustrates, by way of example, a diagram of an embodiment of a method for a CFI check with a finer granularity than prior CFI checks.

FIG. 3 illustrates, by way of example, a diagram of an embodiment of build analysis operations, such as can be a part of operation.

FIG. 4 illustrates, by way of example, a diagram of an embodiment of the build time analysis operation when there is no additional entry point data specified.

FIG. 5 illustrates, by way of example, a diagram of an embodiment of the build time analysis operation when there is entry point data.

FIG. 6 illustrates, by way of example, a diagram of an embodiment of a data flow analysis that can be used to perform a shadow verification operation.

FIG. 7 illustrates, by way of example, a diagram of an embodiment of altering the program of FIG. 6 to generate a modified program that includes the program of FIG. 6 with shadow verification.

FIG. 8 illustrates, by way of example, a diagram of an embodiment of a data flow analysis that can be used to help perform the build time insertion of code.

FIG. 9 illustrates, by way of example, a diagram of an embodiment of program code that, when executed, performs build time insertion and shadow verification.

FIG. 10 illustrates, by way of example, a diagram of an embodiment of build time insertion and shadow verification on a task local reference target.

FIG. 11 illustrates, by way of example, a diagram of an embodiment of build time insertion and shadow verification when task local entry data is provided.

FIG. 12 illustrates, by way of example, a diagram of an embodiment of a data flow analysis that can be used to help perform build time insertion and shadow verification for a recursive function.

FIG. 13 illustrates, by way of example, a diagram of an embodiment of using shadow verification on a shadow verification stack call site.

FIG. 14 illustrates, by way of example, a diagram of an embodiment of updating code to remove indirect branches.

FIG. 15 illustrates, by way of example, a diagram of an embodiment of a data flow analysis that can be used to remove indirect branches.

FIG. 16 illustrates, by way of example, a diagram of an embodiment of removing the indirect branches.

FIG. 17 illustrates, by way of example, a block diagram of an embodiment of a machine on which one or more of the methods, such as those discussed about FIG. 2 and elsewhere herein can be implemented.

### DETAILED DESCRIPTION

Embodiments generally relate to devices, systems, and methods for reducing a likelihood that a device will be affected adversely by a cyberattack, such as a gadget attack.

Embodiments can provide cyber protection using control flow integrity (CFI) using Edge Verification and Elimination (EVE). EVE is a software hardening CFI technique that can insert checks at indirect branch calls sites to verify target jumps against a whitelist of acceptable targets. The whitelist can be created through a build time Call Tree Analysis (CTA) in some embodiments. Embodiments can replace an indirect branch call with a direct branch to a whitelist entry. Such a replacement can help eliminate any possibility of an attacker maliciously using the indirect branch. Embodiments can include a method of runtime pruning the whitelist or a method of shadow verification against the expected target, which can effectively achieve exact CFI checks if the entry point has a one-to-one relation with a function.

The runtime pruning includes a selection of a task entry point specific whitelist based on a currently running or executing task. Consider the global whitelist as a tree. The whitelist has entries for every possible entry point into the software application. This is a full tree that is over-whitelisted if the specific entry point is known. Knowing the entry point of a task, many of the whitelist entries can be cutaway because they are no longer valid because a particular point in the global whitelist tree is known (the entry point).

There are two major categories of control flow redirection. The “forward edge” typically includes function pointers and other jump-to operations. The “backward edge” typically includes a return from a function, which can also be redirected to an unattended location.

Both forward and backward edges use “indirect” calls, which means that the jump location is not based relative to the current location, but instead control flow is redirected to a location identified by a variable (either in a register or memory address). Attackers redirect control flow by changing the variable, thus redirecting the indirect call to instead execute code of their choosing.

As previously discussed, verifying or preventing control flow redirection is called CFI. Not all CFI techniques are equal. The criteria for verifying an indirect jump address determines the strength of the CFI technique. This is called the “granularity” of a CFI technique. A “coarser” grained CFI technique is verified against a larger set of allowable destinations, while “finer” grained CFI techniques verify against a smaller set of allowable destinations. The finest grained CFI includes exact verification of the target against the single correct, expected address.

Current forms of CFI have been shown to be weak due to the coarseness of verification. Embodiments herein, sometimes called EVE, provide an in-band CFI verification that offers precise CFI, such as by using control flow graph information that is generated at build time. Embodiments can further incorporate a runtime edge pruning technique which refines a whitelist (a list of allowable destinations) based on an executing context. When applicable, embodiments offer a method of achieving exact CFI, such as through shadow copy verification.

Control flow occurs linearly through a code base until either a direct branch or indirect branch is taken. A direct branch is “direct” because the target is directly known from the instruction. A destination for a direct branch is decided at build time and hardcoded into the instruction. The target to which to jump is either fully encoded within the instruction as an absolute address or is encoded as a relative offset from the current instruction. Direct branches are not generally considered exploitable because redirecting direct branches would require the attacker to modify the instruction itself. Hardware protections exist to prevent this, and it is reasoned that if an attacker can circumvent these protections, the attacker has already won.

An indirect branch is “indirect” because it jumps to a location that is not encoded directly into the instruction, but rather identified at runtime by a variable (either in a register or memory address). An attacker can redirect control flow for an indirect branch by modifying the variable to the target they desire.

The following explanations provide background and an overview of security concepts which will be discussed in relation to EVE and CFI.

Time of Check to Time of Use (ToCToU) is a possible vulnerability for a security check that occurs if there is an opportunity for an attacker to modify an item being checked after the security check and before use of the item. For CFI checks, an example of a ToCToU vulnerability can be found in Control Flow Guard, from Microsoft Corporation of Redmond Wash., United States of America. Control Flow Guard calls a check function to check the target and then jumps to the target if the check function passes. An attacker can modify the variable being checked after the security check passes and before the jump uses the variable.

Residual risk is the remaining risk or vulnerability after safeguards and controls have been put in place. In relation to security, residual risk can be seen as remaining vulnerabilities or possibilities of defeating incorporated security measures.

A whitelist is a list of acceptable values. A blacklist is a list of unacceptable values. As an illustrative example, consider an address security check. The acceptable addresses are part of the whitelist. All other addresses are part of the blacklist.

Call Tree Analysis (CTA) analyzes the relationship between subroutines in a program. The output of CTA is typically represented as a CF graph, sometimes called a call graph or a call multi-graph.

Data Flow Analysis (DFA) is a technique for gathering information about a possible set of values calculated at various points in a computer program. DFA analyzes the flow of data through a program. DFA can be coupled with a CFG of a program to identify instances of variable declaration, access, or modification. As the target of an indirect call is identified by the contents of a variable, DFA can allow for generating the CFG for indirect call sites. During CFG generation, some form of DFA can be performed and a resulting Data Flow Diagram (DFD) can be created.

A glitch attack occurs when an attacker executes a physical attack on a system to cause the execution of a program to skip forward a certain number of instructions. Glitch attacks can be used to bypass security checks.

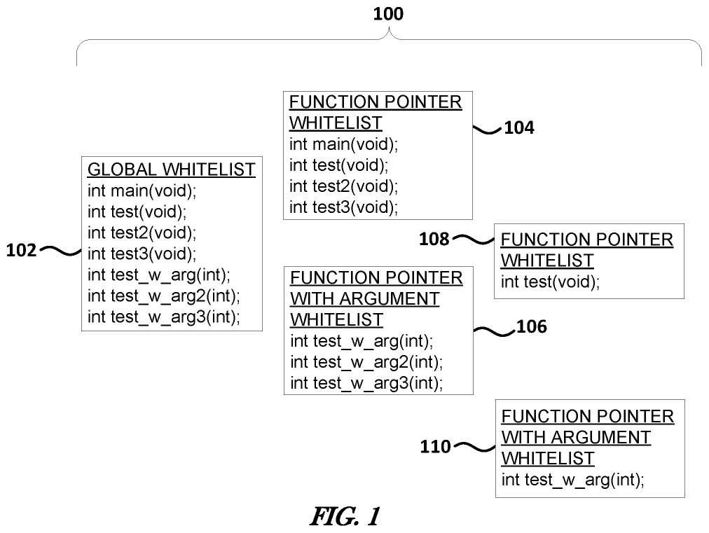

FIG. 1 illustrates, by way of example, a diagram of whitelists 100 with different granularities. A global whitelist 102 uses a coarse grained forward edge CFI check that verifies that an indirect call target is in a list of globally allowed targets. Control Flow Guard is an example of a CFI technique that uses the global whitelist 102. The global whitelist 102 can be checked for all forward edge sites. The global whitelist 102 can be created through compiler analysis, such as to determine all possible target functions. At a simplified level, the analysis can create the global whitelist 102 out of all address function symbols.

In Control Flow Guard, a bitmask is created, where each 2 bits represents a 16 byte address range. The 2 bits allow for fuzzy matching, or exact matching. If the function address is 16 byte aligned, then target addresses will be exactly matched. However, if the function address is not 16 byte aligned, then the 2 bits will be binary “11” which allows a target address that matches anywhere within that 16 byte address range. The Control Flow Guard whitelist thus still permits the attacker to jump to a global set of function starts, which is call site agnostic. Further, the fuzzy matching on unaligned function addresses allows for any address within that 16 byte range, further providing additional addresses for an attacker to use.

Finer-grained whitelists 104, 106 can be generated by a forward edge CFI check that does function type checking for indirect calls. The finer-grained whitelists 104, 106 reduce the global whitelist 102 to a set of functions that match the return type and arguments of an indirect call variable. However, these function type sets can still be very large depending on the code base and function type, possibly leaving the attacker a large attack space to exploit. Clang/LLVM is an example of a program that implements a function type CFI check.

Even finer-grained whitelists 108, 110 can be generated by embodiments. Embodiments can reduce the finer-grained whitelists 104, 106 to only those addresses at which the function resides. More details regarding how to achieve the finer-grained whitelists 108, 110 are provided with regard to other FIGS.

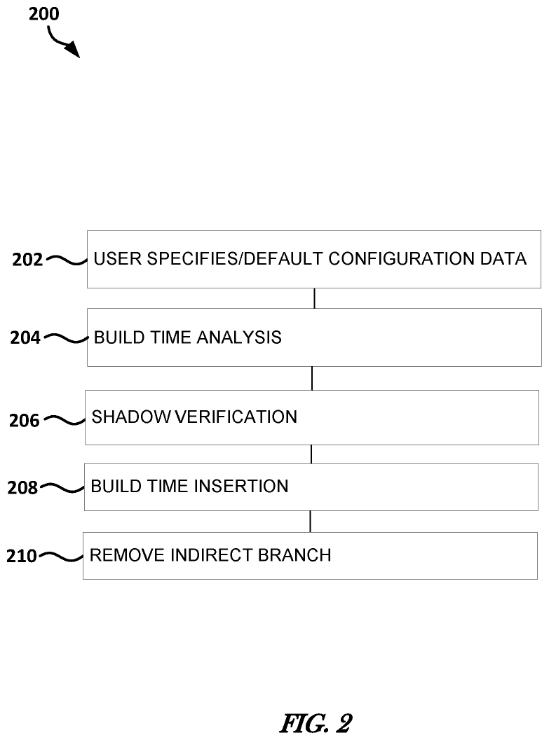

Embodiments can provide a build time, in-band CFI verification technique. Embodiments can perform CFI verification using two or more of the following operations: a build time analysis, a build time insertion, a shadow verification, and a runtime verification step. These operations are discussed in more detail with regard to FIGS. 2-17.

Embodiments can provide finer-grained CFI checks than prior CFI checks. Embodiments can provide configurability in the granularity of the CFI checks, with finer-grained CFI checks consuming more computation bandwidth than coarser-grained CFI checks. Embodiments can provide a user an ability to choose between granularity and computation bandwidth consumption. A user can choose between a standard operation (EVE standard (EVES)), runtime edge pruning (EVEREP), and/or shadow verification (EVESV). Each of the operation configurations can be performed on forward and backward edges of a program. Note that the FIGS. are illustrative and show by way of example, not by way of limitation, high-level code pseudocode examples of embodiments. Pseudocode is used, as embodiments are language and architecture agnostic and are widely applicable.

FIG. 2 illustrates, by way of example, a diagram of an embodiment of a method 200 for a CFI check with a finer granularity than prior CFI checks. The method 200 as illustrated includes identifying configuration data, at operation 202; performing a build time analysis of a program, at operation 204; performing a shadow verification, at operation 206; performing a build-time insertion, at operation 208; and removing an indirect branch in program code, at operation 210.

Operation 202 can include identifying configuration data received through a user interface. Operation 202 can additionally, or alternatively, include identifying default configuration data.

Operation 204 can include generating a CF graph. The CF graph can be generated using CTA, such as for each call site. The CF graph can be used to create a whitelist of acceptable targets for each call site. A call site is the location of an indirect jump. This offers more precise CFI, as whitelists are call-site specific.

At operation 204, whitelists can be generated for both forward and backward edges. Forward edges can include virtual function pointers. A virtual function pointer can provide attackers with an ability to perform a counterfeit object-oriented programming (COOP) attack. In a COOP attack, an attacker hijacks a virtual table lookup, such as to redirect control flow. EVE can leverage commercial compilers that allow for precise CF graphs for virtual function pointers to mitigate these classes of attacks.

At operation 204, the return addresses (sometimes called backward edges) can be determined through CTA. For each function call in the CF graph, the instruction immediately after the function call and in the calling function can be added to a whitelist for the return call site of the called function.

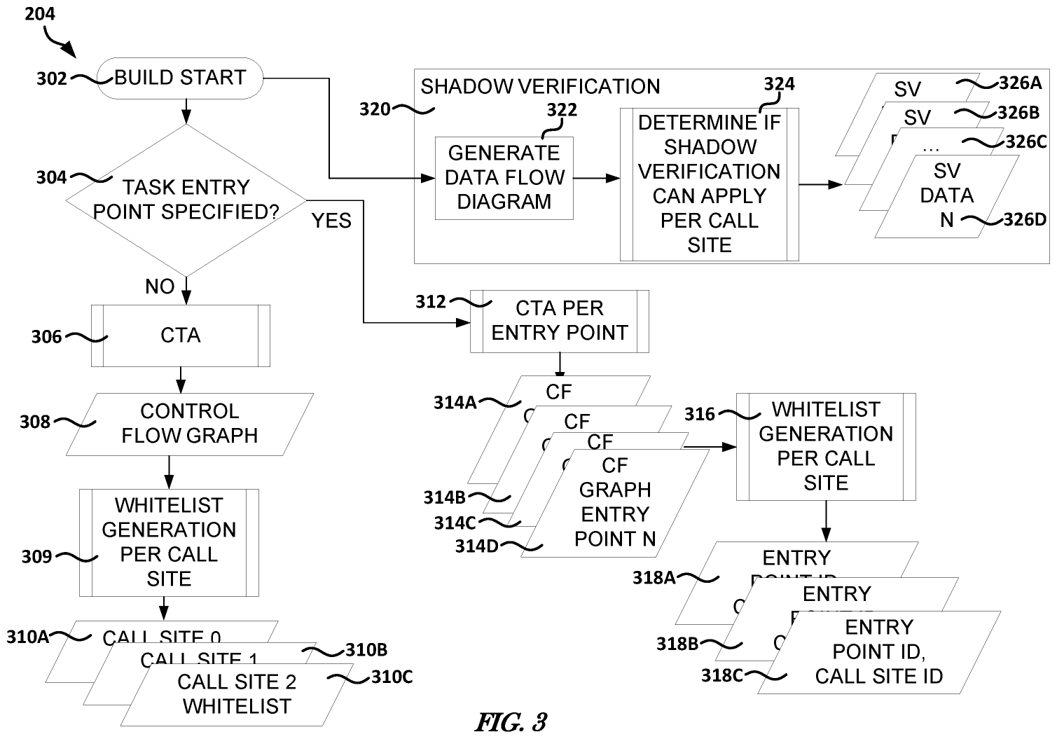

FIG. 3 illustrates, by way of example, a diagram of an embodiment of build analysis operations, such as can be a part of operation 204. The operation 204 can include receiving a build request to initiate a program build start, at operation 302. At operation 304, it can be determined if one or more task entry points are specified. If a task entry point is not specified, a CTA can be performed on the program at operation 306. The CTA can generate CF graph data 308. At operation 309, one or more whitelists 310A, 310B, 310C can be generated per call site based on the CF graph data 308.

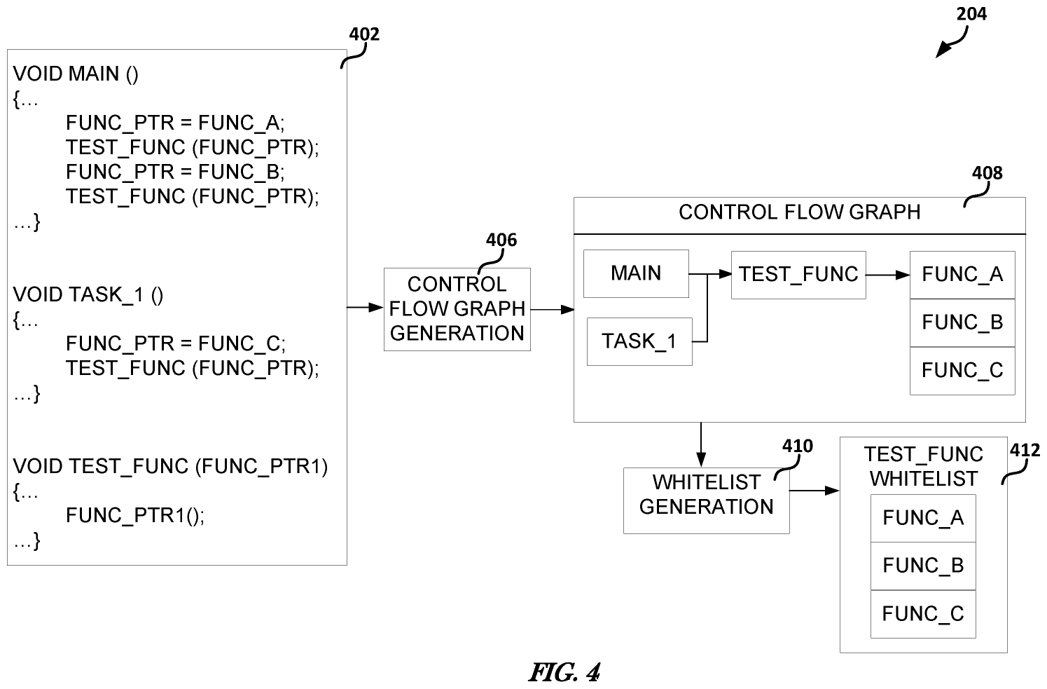

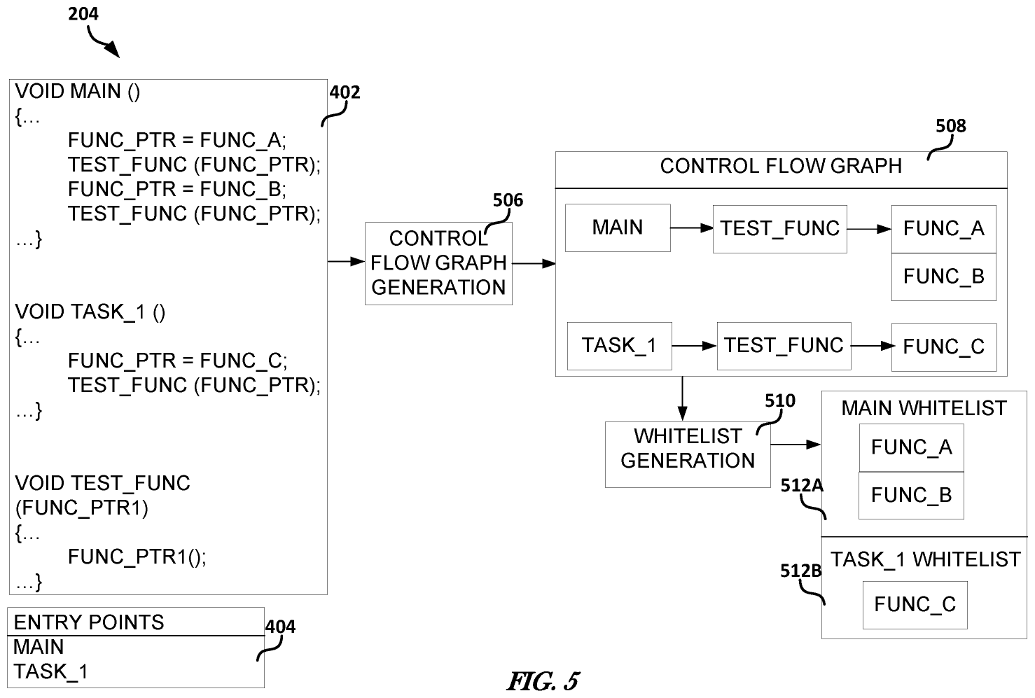

In response to determining, at operation 304, that the task entry point is specified, CTA can be performed per entry point, at operation 312. The CTA at operation 312 can be more granular than the CTA at operation 306 because of the additional task entry point data. The operation 312 can produce data 314A, 314B, 314C, 314D of a CF graph per entry point. At operation 316, one or more whitelists 318A, 318B, 318C, can be generated per each entry point, based on the CF graph data 314A-314D. The operation 316 can produce whitelists 318A-C per call site that is task entry point specific (more granular than the whitelist 310A-310C). More details regarding the different granularities are provided with regard to FIGS. 4-5, among others.

Shadow verification data can be gathered at operation 320, such as in parallel with other operations of the build analysis operation 204. The operation 320 can include generating a DFD, at operation 322. The CF graph, indicated by the CF graph data 308 or 314A-314D, details function calls and which functions call other functions. The DFD generated at operation 322, in contrast, details how data flows between the functions and memory locations.

At operation 324, it can be determined if shadow verification can be applied per call site. Shadow verification can be applied if there is a one-to-one correspondence between a function and an entry point. In some embodiments, shadow verification can be applied where there is a one-to-one mapping between the function and entry point and not applied where there is no such one-to-one mapping. The operation 324 can produce SV data 326A, 326B, 326C, 326D for each call site that has a one-to-one mapping. The SV data 326A-326D can include an identification of the function and the corresponding entry point.

FIG. 4 illustrates, by way of example, a diagram of an embodiment of the build time analysis operation 204 when there is no entry point data specified at operation 304. A software program 402 is provided. The software program 402 includes a function pointer as an input to a function. At operation 406 a CF graph 408 can be generated. In the program 402, both main( ) and task_1( ) call test_func( ). The test_func( ) can be entered at values func_a, func_b, and func_c. At operation 410, a whitelist 412 is generated for each function. In this embodiment, the whitelist 412 includes all three entry points func_a, func_b, and func_c.

FIG. 5 illustrates, by way of example, a diagram of an embodiment of the build time analysis operation 204 when there is entry point data specified, such as at operation 304. The same software 402 is provided and the same entry points are identified 404 as in FIG. 4. However, since entry point data is provided, a different, more granular CF graph 508 can be generated at operation 506. Note that the entry point for test_func( ) when it is called by task_1( ) is func_c while the entry point for test_func( ) is one of func_a and func_b when called by main( ). This can be more clearly delineated when entry point data is provided, such that separate whitelists 512A, 512B for main( ) and task_1( ), respectively, can be generated at operation 510. In this manner, an entry point check can prevent an attacker from entering test_func( ) at func_c through main( ) and entering test_func( ) at func_a or func_b through task_1( ). This helps prevent the use of gadgets by limiting the entry points to the functions to only those on the function whitelists 512A, 512B.

Operation 206 can include using DFA and a resulting DFD, such as can be generated at operation 204, to identify call sites at which to apply shadow verification. Shadow verification can be applied if a target of a call site can be uniquely determined, such as at runtime. For shadow verification, this can mean there is a one-to-one correlation that can be determined between a call site and what the call site is referencing.

The operation 206 can be performed differently for forward edges and backward edges. Each is discussed in turn.

For forward edge shadow verification, there are at least three different types of shadow references: (1) globally scoped references, (2) loop references, and (3) task local scoped references. These three types of shadow references can differ in the analysis and checker insertion mechanisms. For example, each of these reference types can be stored and accessed differently.

Call sites that reference global function pointers can be immediately identified as having a one-to-one mapping between a function and an entry point. Since a global function pointer is a single entity, it is determinable at runtime. To verify CFI, a comparison can be made against a shadow copy of the global function pointer. The global function pointer call sites utilize globally scoped shadow references and are sometimes called Global Reference Sites (GRS).

A loop reference is a call site that use references which originate in recursive calls. Functions in a call graph loop can be made one-to-one through pushing and popping the shadow copy onto a stack structure. The added instructions for such shadow verification are sometimes called Shadow Verification Stack Call Sites (SVSCS). These shadow stacks are task and call site specific, such as to include one per task per call site.

All other references can be considered task local scoped references. These references can be represented as an entry in a task local structure. Since there is only one of each of these references per task (loops are handled in SVSCS), each can be given a unique entry in a structure. The added instructions to perform a shadow verification on a local scoped reference are sometimes called Task Local Reference Sites (TLRS).

The quality of the DFA can determine how many call sites can be protected with shadow verification. In embodiments where the CTA and DFA results in insufficient graphs to perform shadow verification on call sites, shadow verification can be foregone, such as at the expense of some security.

Backward edge shadow verification can have a one-to-one mapping, since the return address is popped onto the stack. This one-to-one mapping effectively creates a unique “variable” per function call. Shadow verification on the return address is sometimes called a shadow stack verification. Although shadow stacks are by themselves an effective, exact, lightweight backward edge CFI check, applying embodiments with shadow stacks can provide greater depth of defense. With embodiments that include reinforcing shadow stacks for backward edges, even if the shadow stack was defeated, the attacker can be restricted to addresses on the whitelist.

Shadow stacks are already considered to be effective. Whether the defense in depth provided for backward edges by embodiments is worth the performance cost is only determinable by a user and their security and performance requirements.

The operation 206 can include using the generated whitelists from the operation 202 and creating pointer checkers for each call site. The checker can include one or more instructions that verify a target destination is on the whitelist for that call site. The checker can, if the target matches, perform a direct jump to the target destination. If the target destination does not match an entry on the whitelist for the call site, then a CFI violation can be raised. A CFI violation can include logging accompanying details for forensics, such as can be sent to a monitor for intrusion detection or future attack avoidance. The original possibly exploitable indirect jump can be removed at operation 208. This offers more precise verification over prior CFI techniques, such as can include exact precision.

The operation 206 can rely on modifications to the entry point reference failing the shadow copy check. There are at least two ways to prevent attackers from defeating shadow verification through defeating the shadow copy. First, an attacker can be prevented from modifying the shadow copy. Second, the attacker can be prevented from knowing what value to write to the shadow copy to successfully bypass the shadow verification check.

Preventing invalid writes to the shadow copy can be achieved through various techniques. In one technique, the shadow copy can be placed in a region of memory that is write-protected unless authorized. For example, the shadow copies can be placed in a read-only region and trapped to an exception handler on writes. The exception handler can verify that the instruction causing the write is on a whitelist of acceptable locations. The acceptable locations can be the instructions inserted by the build time insertion step that modify the shadow copy.

Preventing non-authorized writes, however, can likely cause a performance degradation due to the extra kernel traps and exception code. Another technique of thwarting an attacker can include transforming the value written into the shadow copy in a manner that is difficult for an attacker to discover. An effective but low-impact implementation can include performing an XOR operation on a value with a runtime generated secret key before writing it to the shadow copy. At the operation 206, the value in the shadow copy can be transformed back to the original value through an XOR with the secret key. To defeat this, the attacker would have to exfiltrate the secret key at runtime.

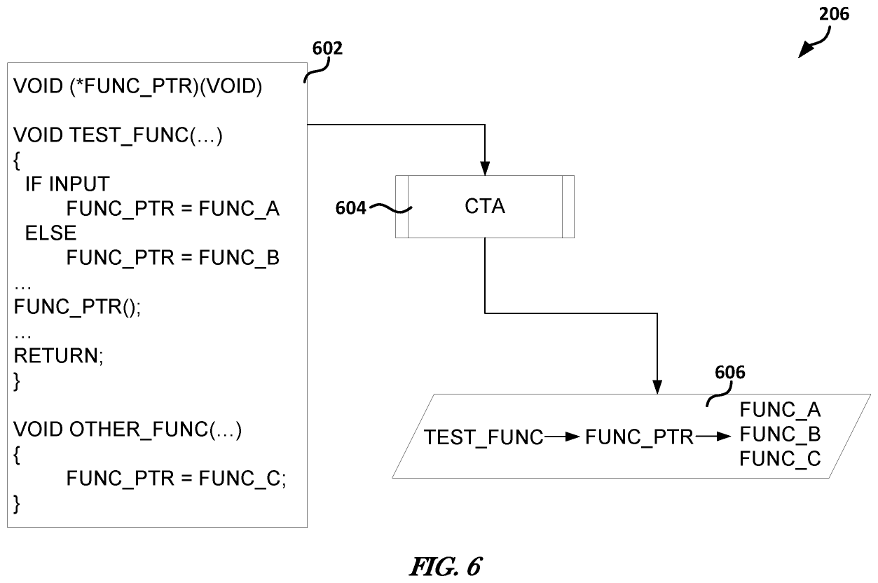

FIG. 6 illustrates, by way of example, a diagram of an embodiment of a data flow analysis that can be used to perform the operation 206. FIG. 6 includes a program 602 on which a CTA is performed at operation 604 to generate a CF graph 606. The CF graph 606 can be used to identify whether there is a one-to-one relation between an entry point and a function. If so, shadow verification can be applied to that call site.

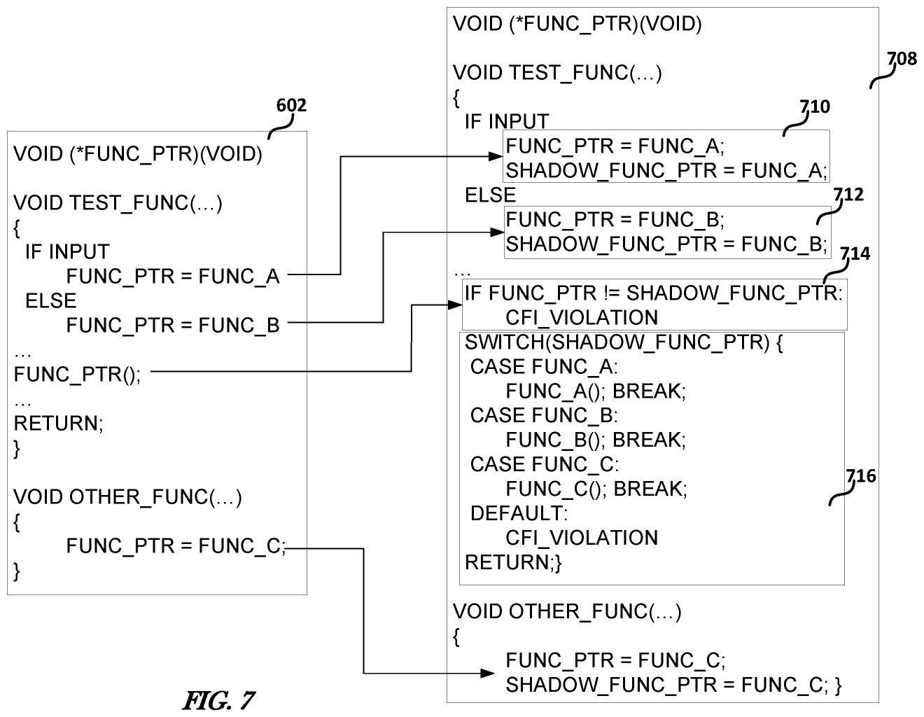

FIG. 7 illustrates, by way of example, a diagram of an embodiment of altering the program 602 to generate a program 708 that includes the program 602 with shadow verification. The program 708 includes instantiating a shadow pointer every time a function pointer that includes a one-to-one relation between entry point (entry point to which the function pointer corresponds) and function. These are illustrated at inserted code 710 and 712. The program 708 additionally includes a shadow pointer check, at code 714, to determine whether the function pointer is equal to a shadow value of the pointer. If not, a control flow integrity (CFI) violation is issued. A whitelist 716 that references the shadow function pointer, rather than the function pointer, can provide an ability to dynamically alter the whitelist 716 and help gain security, such as over a whitelist that references the function pointer that is more likely to be altered by an attacker.

The operation 208 can include adding or modifying code or a program to include CFI checks, such as whitelist verification or shadow verification. The operation 208 can insert comparisons, copy variables, reference function local structures, or the like to achieve the CFI checks.

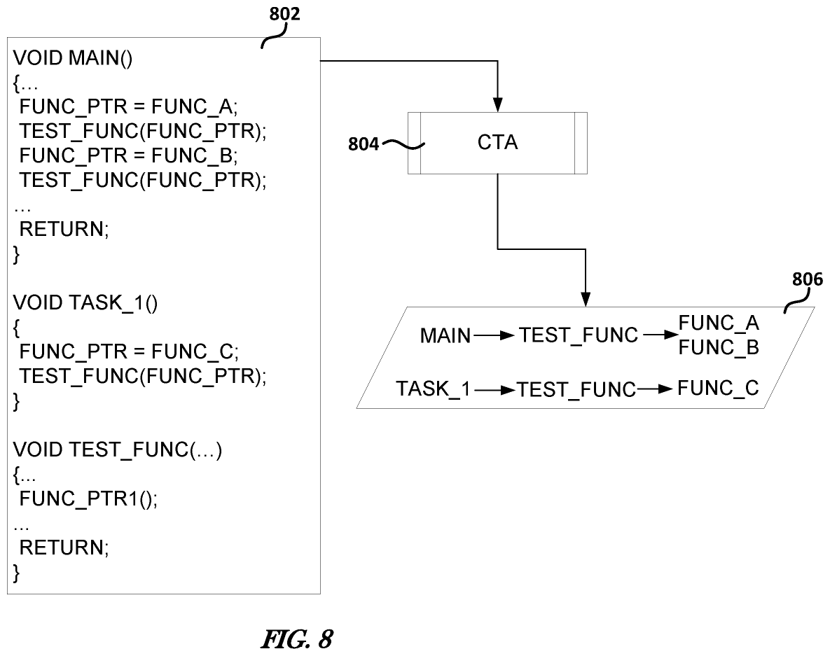

FIG. 8 illustrates, by way of example, a diagram of an embodiment of a data flow analysis that can be used to help perform the operation 208. FIG. 8 includes a program 802 on which a CTA is performed at operation 804 to generate a CF graph 806. The CF graph 806 can be used to identify points where dynamic whitelist generation can be beneficial.

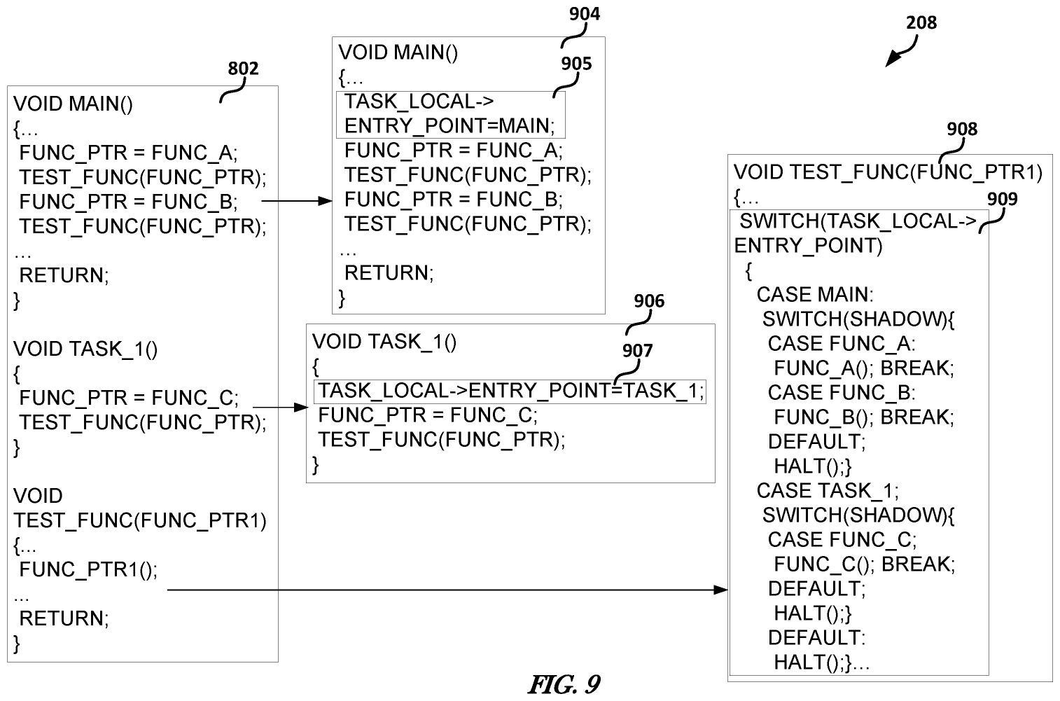

FIG. 9 illustrates, by way of example, a diagram of an embodiment of program code that, when executed, performs the operation 208. The program 802 includes three functions “main( )”, “task_1”, and “test_func( )” that are transformed, such as at build time into program code 904, 906, and 908, respectively. The “task_local” pointer at code 905 and 907 points to a data structure. This data structure can hold metadata. For example, the data structure can hold the entry point at code 905 or 907 for the executing task such as to be used later to choose the entry point specific whitelist 909. The code 905 and 907 can be inserted code at a beginning of each task entry point. The code 905 and 907 can allow for dynamic association of a task and an entry point. This dynamic association can provide an ability to dynamically generate a whitelist 909. The program code 908 uses the entry point of the currently running task to get the task specific whitelist 909. The whitelist 909 can be hardcoded into the code base. In the example of FIG. 9, the whitelist 909 is shown as a switch statement, but this is just for the sake of illustration and not limitation.

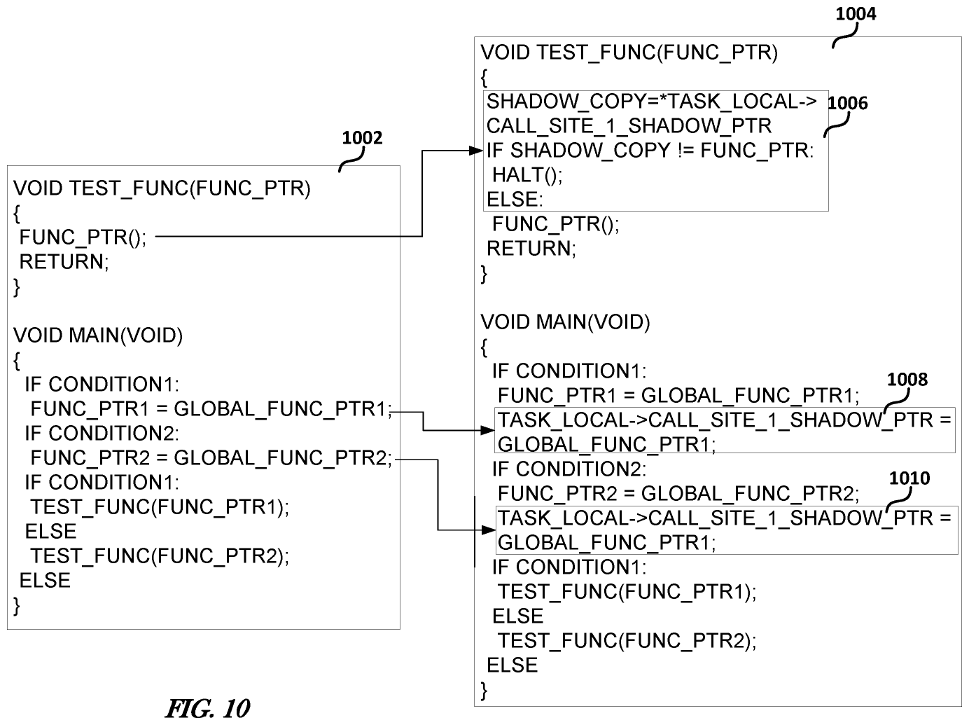

FIG. 10 illustrates, by way of example, a diagram of an embodiment of the operation 208 for performing the operation 206 on a task local reference target. In FIG. 10, program code 1002 is converted to program code 1004. The operation 208 can include creating a shadow copy of the entry point for each task. The operation 208 can includes using DFA to identify each location a reference to a task is updated. Program code can be inserted at each of the identified locations to update a shadow copy of a pointer to a currently executing task. The operation 208 can include inserting program code that compares a target of an indirect branch to a task specific shadow copy of the entry point. In FIG. 10, the “task_local” pointer points to a task specific data structure. Program code 1008 and 1010 provide shadow copy insertion and update. Because there is a shadow copy per task, the shadow copy is accessed through the “task_local” structure which accesses the task specific shadow copy. Program code 1006 provides the shadow copy verification which is also illustrated as a task specific shadow copy and is thus accessed through the “task_local” structure.

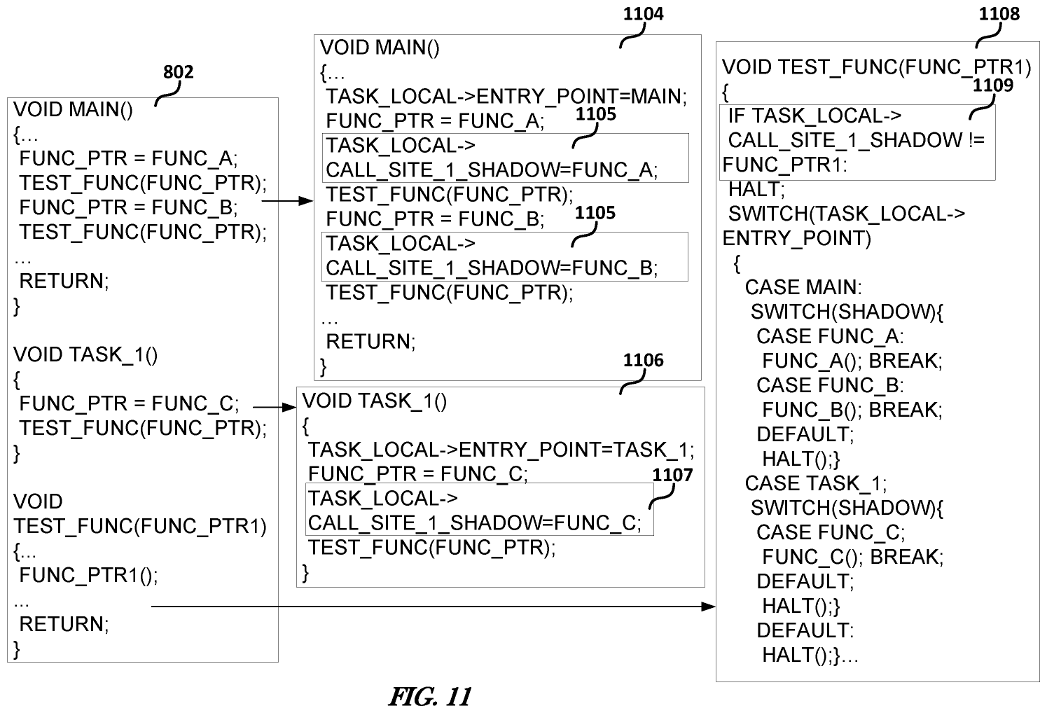

FIG. 11 illustrates, by way of example, a diagram of an embodiment of the operation 208 to perform the operation 206 when task local entry data is provided. A CF graph 806 for the program code 802 is provided in FIG. 8. The program code 802 can be modified to include modified functions 1104, 1106, and 1108. The modified functions 1104 and 1106 can include program code 1105 and 1107, respectively, inserted at an entry point to update a shadow copy of the entry point. As previously discussed, the entry points can be identified using a DFA. As in FIG. 10, the shadow copy can be accessed through the “task_local” structure. The modified function 1108 can include the program code 1109 inserted to perform shadow verification of the shadow copy. The shadow copy can be accessed through the “task_local” structure.

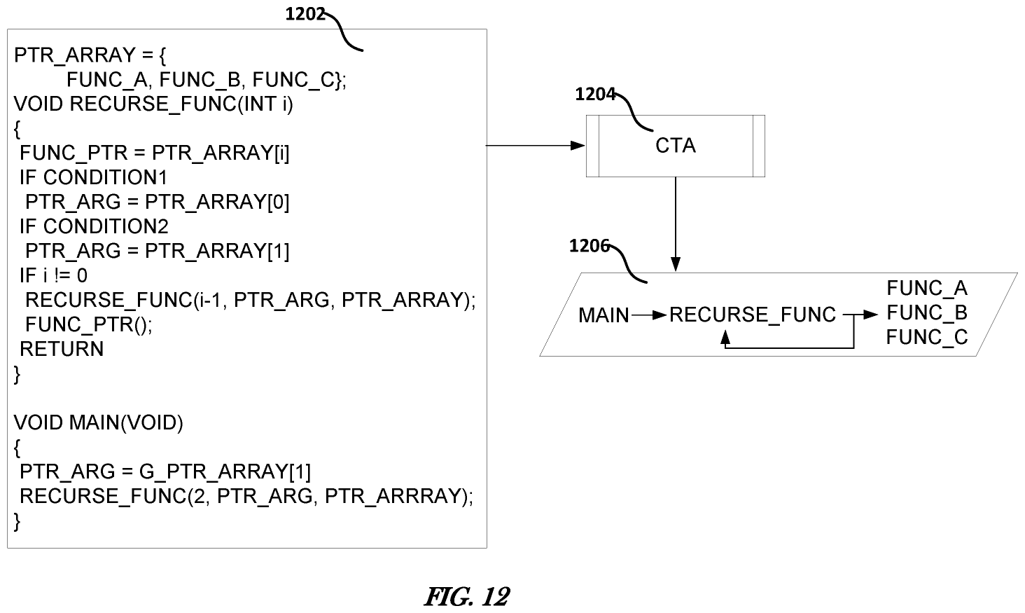

FIG. 12 illustrates, by way of example, a diagram of an embodiment of a data flow analysis that can be used to help perform the operation 1208 for a recursive function. FIG. 12 includes a program 1202 with a recursive function on which a CTA can be performed at operation 1204. The operation 1204 can be used to generate a CF graph 1206. The CF graph 1206 can be used to identify points where dynamic CFI can be beneficial.

For recursive functions, a shadow verification stack can be generated, such as at operation 208, per call site (entry point). To create the shadow verification stack per entry point, a more detailed analysis and interpretation of a DFD can be performed. To generate the stack per entry point, a function local shadow copy of a reference variable can be created. Then a shadow stack can be generated per call site per task. A DFA can be used to identify a location the reference variable is updated. Wherever the reference variable is updated, a shadow copy of the reference variable can also be updated. Using DFA, an instruction immediately before the recursive call can be identified. At this point, it can be determined that the reference variable will no longer be updated. The shadow reference variable value can be pushed onto the shadow stack. Then a checker can be inserted at the call site that pops off the top value of the shadow stack. The value can then be compared to the target of the indirect branch. Operation can continue unless the check fails.

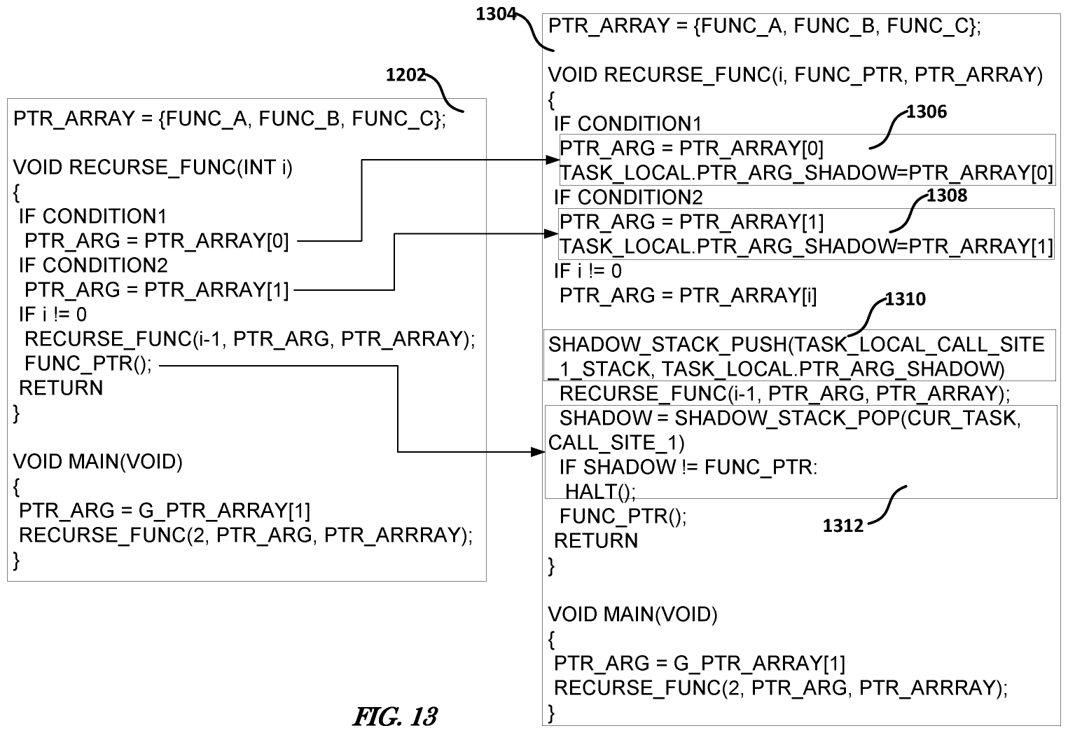

FIG. 13 illustrates, by way of example, a diagram of an embodiment of the operations 206 and 208 using shadow verification on a shadow verification stack call site. The shadow verification stack call site can be used when the program code includes a function reference local to a recursive function, such as the program 1202. Program code 1304 includes the program code 1202 with shadow verification. Inserted program code 1306 and 1308 are examples of updating a shadow copy of a shadow variable immediately after a reference variable is updated. Inserted program code 1310 is an example of pushing a shadow reference variable value onto a shadow stack. This is the instruction immediately before a recursive function call. Inserted program code 1312 is an example of shadow copy verification by popping a shadow reference variable value from the shadow stack.

An example of a DFA application is Static Value Flow in the LLVM software suite. Other DFA applications are within the scope of embodiments.

Code can be inserted at the beginning of each task entry point which associates the executing task with a task entry point. Such code insertion can allow for dynamic task creation and mapping, instead of statically defining the number of tasks and associations to their task entry points at build time.

Operation 210 includes removing a possibly exploitable indirect jump, preventing any possibility of exploitation of the indirect jump. Other proposed CFI techniques have not removed the indirect branch, leaving the residual risk that an attacker defeats the CFI technique and gains control flow. This also effectively means that embodiments, unlike other proposed CFI techniques, have no ToCToU vulnerability. The removal of this vulnerability keeps embodiments safer from glitch attacks. There is no ToCToU vulnerability because the indirect jump is removed. The operation 210 can include hardcoding the jump. Since the target is hardcoded, once the check has been done, the code flow is already set to jump to the target and cannot be manipulated to jump anywhere else. This ensures that the attacker is limited to targets on the whitelist, even if they had full access to the target variable.

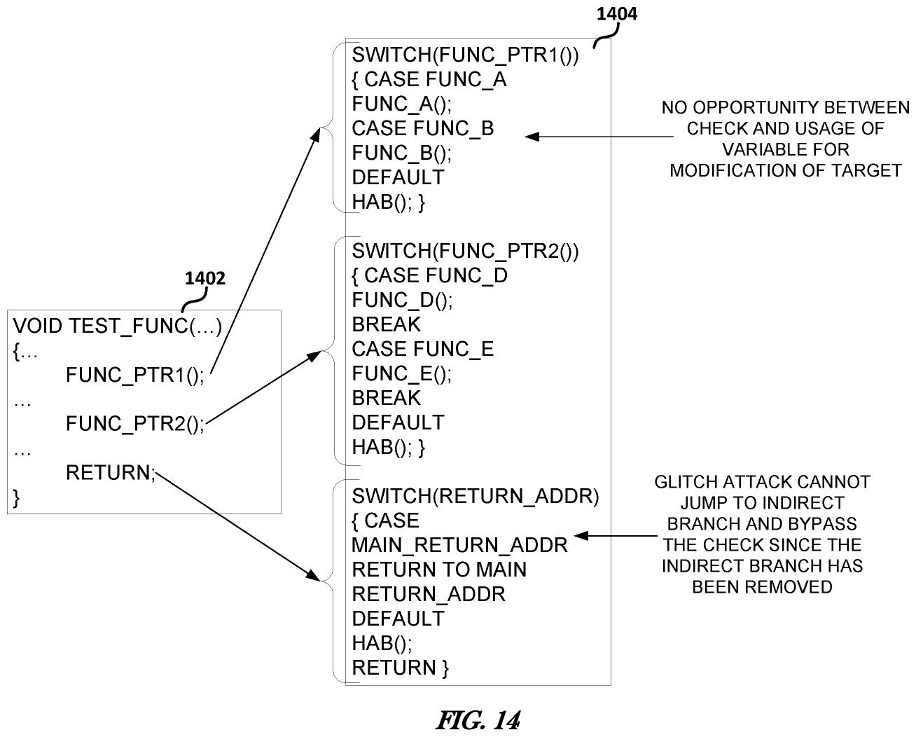

FIG. 14 illustrates, by way of example, a diagram of an embodiment of updating code to remove indirect branches, such as at operation 210. An example program 1402 can be modified at every indirect branch. Each indirect branch can be replaced with a conditional statement, as is included in modified program code 1404. The modified program code can include a switch statement as illustrated in FIG. 14 or the like. The conditional statement, instead of branching indirectly, can directly call the task based on the entry point. Using the switch statement, the opportunity to exploit a ToCToU issue in the program code 1404 is removed. Further, a glitch attack cannot jump to an indirect branch and bypass a check performed by the conditional statement since the indirect branch is removed.

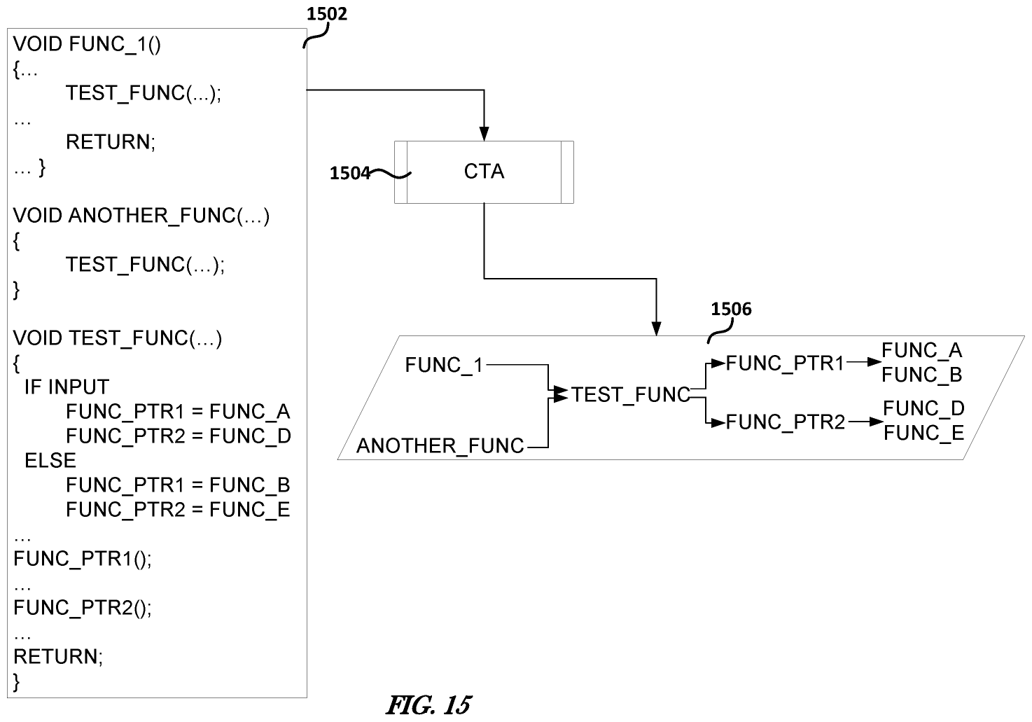

FIG. 15 illustrates, by way of example, a diagram of an embodiment of a data flow analysis that can be used to help perform the operation 210. FIG. 15 includes a program 1502 on which a CTA is performed at operation 1504 to generate a CF graph 1506. The CF graph 1506 can be used to identify points where indirect branches can be replaced with direct branches.

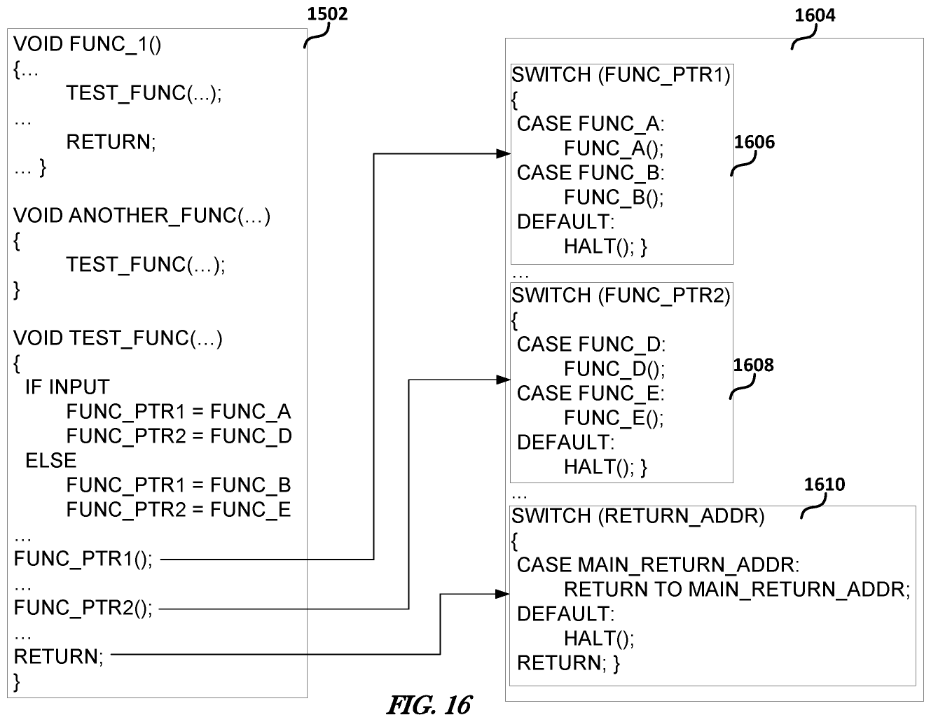

FIG. 16 illustrates, by way of example, a diagram of an embodiment of performing the operation 210. The program code 1502 can be modified to remove indirect branches and generate modified program code 1604. The modified program code 1604 includes whitelist checker code 1606, 1608, and 1610 that removes indirect branches. Instead of relying on the variable “func_ptrX” the modified code 1606, 1608, and 1610 directly calls a function. The conditional statement (switch statements in the example of FIG. 16), at the same time, performs a whitelist check that issues a CFI violation (via the “halt( )” function) if the whitelist check fails.

The inserted checks of embodiments provide a performance penalty due to the whitelist verification check, shadow variable instantiation or check, or the like. In the FIGS., a switch statement was used for simplicity to illustrate the check. This approach, if used, would take O(n) time, meaning that the time to perform the check would linearly increase as the number of entries on the whitelist increases. However, the CFI verification checks can be optimized through the various techniques.

The verification checks of embodiments can be optimized through insertion of a binary traversal rather than a linear switch statement. Because the whitelist can be sorted at build time, an efficient binary traversal of the whitelist can be hardcoded into the instructions. This differs from a full binary search implementation in that the binary division points can be pre-calculated and the inserted instructions are only for the traversal of the binary tree. A binary traversal takes logarithmic time, or O(log n).

The verification check of embodiments can be inserted as a direct lookup into a map. For each address taken, a trampoline function can be created which jumps to the function. All places in the code that take the address of a function can be provided the address of the trampoline function. The trampoline functions can be placed consecutively in memory, essentially mapping the original functions into a condensed map.

As discussed, embodiments can reduce a vulnerability to glitch attacks because embodiments remove indirect branches. Even if a glitch attack bypasses the check, the attacker will be limited to the set of targets on the whitelist.

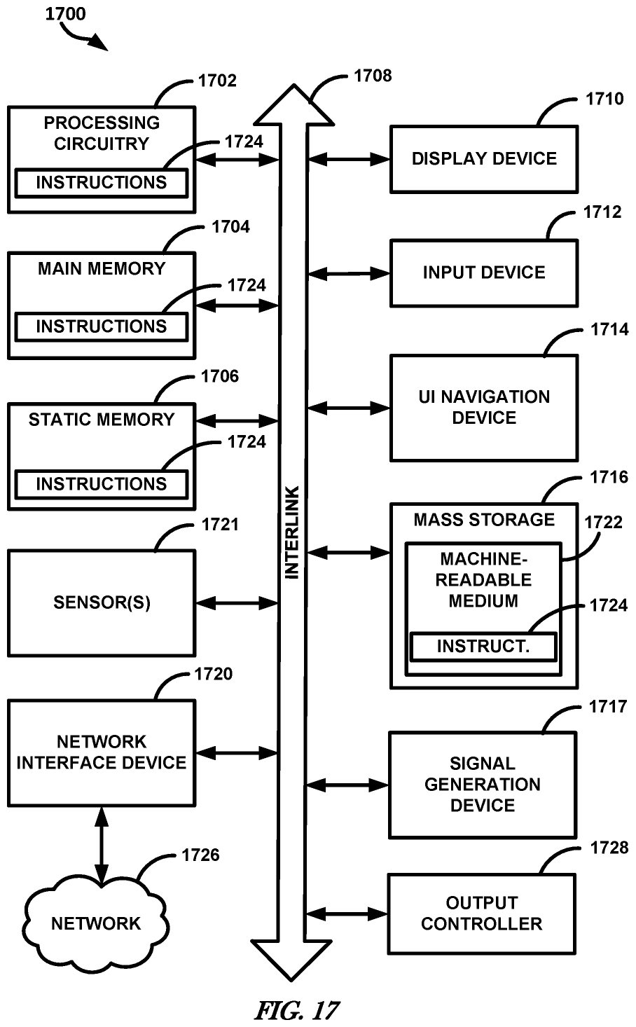

FIG. 17 illustrates, by way of example, a block diagram of an embodiment of a machine 1700 on which one or more of the methods, such as those discussed about FIGS. 2-16 and elsewhere herein can be implemented. In alternative embodiments, the machine 1700 operates as a standalone device or may be connected (e.g., networked) to other machines. In a networked deployment, the machine 1700 may operate in the capacity of a server or a client machine in server-client network environment, or as a peer machine in a peer-to-peer (or distributed) network environment. The machine 1700 may be a personal computer (PC), a tablet PC, a set-top box (STB), a Personal Digital Assistant (PDA), a cellular telephone, a web appliance, a network router, switch or bridge, embedded computer or hardware, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example machine 1800 includes processing circuitry 1702 (e.g., a hardware processor, such as can include a central processing unit (CPU), a graphics processing unit (GPU), an application specific integrated circuit, circuitry, such as one or more transistors, resistors, capacitors, inductors, diodes, logic gates, multiplexers, oscillators, buffers, modulators, regulators, amplifiers, demodulators, or radios (e.g., transmit circuitry or receive circuitry or transceiver circuitry, such as RF or other electromagnetic, optical, audio, non-audible acoustic, or the like), sensors 1721 (e.g., a transducer that converts one form of energy (e.g., light, heat, electrical, mechanical, or other energy) to another form of energy), or the like, or a combination thereof), a main memory 1704 and a static memory 1706, which communicate with each other and all other elements of machine 1700 via a bus 1708. The transmit circuitry or receive circuitry can include one or more antennas, oscillators, modulators, regulators, amplifiers, demodulators, optical receivers or transmitters, acoustic receivers (e.g., microphones) or transmitters (e.g., speakers) or the like. The RF transmit circuitry can be configured to produce energy at a specified primary frequency to include a specified harmonic frequency.

The machine 1700 (e.g., computer system) may further include a video display unit 1710 (e.g., a liquid crystal display (LCD) or a cathode ray tube (CRT)). The machine 1700 also includes an alphanumeric input device 1712 (e.g., a keyboard), a user interface (UI) navigation device 1714 (e.g., a mouse), a disk drive or mass storage unit 1716, a signal generation device 1718 (e.g., a speaker) and a network interface device 1720.

The mass storage unit 1716 includes a machine-readable medium 1722 on which is stored one or more sets of instructions and data structures (e.g., software) 1724 embodying or utilized by any one or more of the methodologies or functions described herein. The instructions 1724 may also reside, completely or at least partially, within the main memory 1704, the static memory 1706, and/or within the processing circuitry 1702 during execution thereof by the machine 1700, the main memory 1704 and the processing circuitry 1702 also constituting machine-readable media. One or more of the main memory 1704, the mass storage unit 1716, or other memory device can store the job data, transmitter characteristics, or other data for executing the method 200.

The machine 1700 as illustrated includes an output controller 1728. The output controller 1728 manages data flow to/from the machine 1700. The output controller 1728 is sometimes called a device controller, with software that directly interacts with the output controller 1728 being called a device driver.

While the machine-readable medium 1722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that can store, encode or carry instructions for execution by the machine and that cause the machine to perform any one or more of the methodologies of the present invention, or that can store, encode or carry data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 1724 may further be transmitted or received over a communications network 1726 using a transmission medium. The instructions 1724 may be transmitted using the network interface device 1720 and any one of several well-known transfer protocols (e.g., hypertext transfer protocol (HTTP), user datagram protocol (UDP), transmission control protocol (TCP)/internet protocol (IP)). The network 1726 can include a point-to-point link using a serial protocol, or other well-known transfer protocol. Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that can store, encode or carry instructions for execution by the machine, and includes digital or analog communications signals or other intangible media to facilitate communication of such software.

### Examples and Additional Notes

Example 1 can include a device configured to ensure control flow integrity, the device comprising a memory to store instructions of an application to be executed, the application including a plurality of functions, processing circuitry to identify, based on a data flow analysis, entry points of each of the functions, the entry points including one or more forward edge entry points and one or more backward edge entry points for each function of the functions, generate a whitelist for each function, the whitelist including the identified entry points, and add instructions to the application to include a whitelist check at the entry points to each of the functions.

In Example 2, Example 1 further includes, wherein the processing circuitry is further to maintain a shadow copy of each of the entry points that include a one-to-one correspondence with a function, and use the shadow copy of the entry points in the whitelist check.

In Example 3, at least one of Examples 1-2 further includes, wherein the processing circuitry is further to replace indirect branches in the instructions with direct branches.

In Example 4, Example 3 further includes, wherein the direct branches include respective conditional statements.

In Example 5, at least one of Examples 1-4 further includes, wherein an instruction address immediately after the function call and in the function is on a whitelist for the return call site of the function.

In Example 6, at least one of Examples 1-5 further includes, wherein the processing circuitry is further to form a shadow verification stack for each function of the functions that includes a recursive function that references an entry point.

In Example 7, Example 6 further includes, wherein the processing circuitry is further to add instructions that push a shadow copy of the entry point onto a corresponding shadow verification stack immediately after an instruction that updates an entry point variable of a function of the functions and pops the shadow copy of the entry point off the stack for shadow verification immediately before the function is called.

In Example 8, at least one of Examples 1-7 further includes, wherein the processing circuitry is further to prune the whitelist including a reduction of a whitelist based on an entry point of a function of the plurality of functions at runtime.

Example 9 includes a non-transitory machine-readable medium including instructions that, when executed by a machine, cause the machine to perform operations comprising identifying, based on a data flow analysis, an entry point of each of a plurality of functions of an application, the entry points including one or more forward edge entry points and one or more backward edge entry points for each function of the functions, generating a whitelist for each function, the whitelist including the identified entry points, and adding instructions to the application to include a whitelist check at the entry points to each of the functions.

In Example 10, Example 9 further includes, wherein the operations further include maintaining a shadow copy of each of the entry points that include a one-to-one correspondence with a function, and using the shadow copy of the entry points in the whitelist check.

In Example 11, at least one of Examples 9-10 further includes, wherein the operations further include replacing indirect branches in the instructions with direct branches.

In Example 12, at least one of Examples 9-11 further includes, wherein the direct branches include respective conditional statements.

In Example 13, at least one of Examples 9-12 further includes, wherein an instruction address immediately after the function call and in the function is on a whitelist for the return call site of the function.

In Example 14, at least one of Examples 9-13 further includes, wherein the operations further include forming a shadow verification stack for each function of the functions that includes a recursive function that references an entry point.

In Example 15, Example 14 further includes, wherein the operations further include adding instructions that push a shadow copy of the entry point onto a corresponding shadow verification stack immediately after an instruction that updates an entry point variable of a function of the functions and pops the shadow copy of the entry point off the stack for shadow verification immediately before the function is called.

In Example 16, at least one of Examples 9-15 further includes, wherein the operations further include pruning the whitelist including a reduction of a whitelist based on an entry point of a function of the plurality of functions at runtime.

Example 17 includes a computer-implemented method comprising identifying, based on a data flow analysis, an entry point of each of a plurality of functions of an application, the entry points including one or more forward edge entry points and one or more backward edge entry points for each function of the functions, generating a whitelist for each function, the whitelist including the identified entry points, and adding instructions to the application to include a whitelist check at the entry points to each of the functions.

In Example 18, Example 17 further includes maintaining a shadow copy of each of the entry points that include a one-to-one correspondence with a function, and using the shadow copy of the entry points in the whitelist check.

In Example 19, at least one of Examples 17-18 further includes replacing indirect branches in the instructions with direct branches.

In Example 20, Example 19 further includes, wherein the direct branches include respective conditional statements.

In Example 21, at least one of Examples 17-20 further includes, wherein an instruction address immediately after the function call and in the function is on a whitelist for the return call site of the function.

In Example 22, at least one of Examples 17-21 further includes forming a shadow verification stack for each function of the functions that includes a recursive function that references an entry point.

In Example 23, Example 22 further includes adding instructions that push a shadow copy of the entry point onto a corresponding shadow verification stack immediately after an instruction that updates an entry point variable of a function of the functions and pops the shadow copy of the entry point off the stack for shadow verification immediately before the function is called.

In Example 24, at least one of Examples 17-23 further includes pruning the whitelist including a reduction of a whitelist based on an entry point of a function of the plurality of functions at runtime.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A device configured to ensure control flow integrity, the device comprising:
a memory to store instructions of an application to be executed, the application including a plurality of functions;
processing circuitry to:
identify, based on a data flow analysis, entry points of each of the functions, the entry points including one or more forward edge entry points and one or more backward edge entry points for each function of the functions;
generate a whitelist for each function, the whitelist including the identified entry points; and
add instructions to the application to include a whitelist check at the entry points to each of the functions.

2. The device of claim 1, wherein the processing circuitry is further to:
maintain a shadow copy of each of the entry points that include a one-to-one correspondence with a function; and
use the shadow copy of the entry points in the whitelist check.

3. The device of claim 1, wherein the processing circuitry is further to replace indirect branches in the instructions with direct branches.

4. The device of claim 3, wherein the direct branches include respective conditional statements.

5. The device of claim 1, wherein an instruction address immediately after the function call and in the function is on a whitelist for the return call site of the function.

6. The device of claim 1, wherein the processing circuitry is further to form a shadow verification stack for each function of the functions that includes a recursive function that references an entry point.

7. The device of claim 6, wherein the processing circuitry is further to add instructions that push a shadow copy of the entry point onto a corresponding shadow verification stack immediately after an instruction that updates an entry point variable of a function of the functions and pops the shadow copy of the entry point off the stack for shadow verification immediately before the function is called.

8. The device of claim 1, wherein the processing circuitry is further to prune the whitelist including a reduction of a whitelist based on an entry point of a function of the plurality of functions at runtime.

9. A non-transitory machine-readable medium including instructions that, when executed by a machine, cause the machine to perform operations comprising:
identifying, based on a data flow analysis, an entry point of each of a plurality of functions of an application, the entry points including one or more forward edge entry points and one or more backward edge entry points for each function of the functions;
generating a whitelist for each function, the whitelist including the identified entry points; and
adding instructions to the application to include a whitelist check at the entry points to each of the functions.

10. The non-transitory machine-readable medium of claim 9, wherein the operations further include:
maintaining a shadow copy of each of the entry points that include a one-to-one correspondence with a function; and
using the shadow copy of the entry points in the whitelist check.

11. The non-transitory machine-readable medium of claim 9, wherein the operations further include replacing indirect branches in the instructions with direct branches.

12. The non-transitory machine-readable medium of claim 9, wherein the direct branches include respective conditional statements.

13. The non-transitory machine-readable medium of claim 9, wherein an instruction address immediately after the function call and in the function is on a whitelist for the return call site of the function.

14. The non-transitory machine-readable medium of claim 9, wherein the operations further include forming a shadow verification stack for each function of the functions that includes a recursive function that references an entry point.

15. The non-transitory machine-readable medium of claim 14, wherein the operations further include adding instructions that push a shadow copy of the entry point onto a corresponding shadow verification stack immediately after an instruction that updates an entry point variable of a function of the functions and pops the shadow copy of the entry point off the stack for shadow verification immediately before the function is called.

16. The non-transitory machine-readable medium of claim 9, wherein the operations further include pruning the whitelist including a reduction of a whitelist based on an entry point of a function of the plurality of functions at runtime.

17. A computer-implemented method comprising:
identifying, based on a data flow analysis, an entry point of each of a plurality of functions of an application, the entry points including one or more forward edge entry points and one or more backward edge entry points for each function of the functions;
generating a whitelist for each function, the whitelist including the identified entry points; and
adding instructions to the application to include a whitelist check at the entry points to each of the functions.

18. The method of claim 17, further comprising:
maintaining a shadow copy of each of the entry points that include a one-to-one correspondence with a function; and
using the shadow copy of the entry points in the whitelist check.

19. The method of claim 17, further comprising replacing indirect branches in the instructions with direct branches.

20. The method of claim 19, wherein the direct branches include respective conditional statements.

21. The method of claim 17, wherein an instruction address immediately after the function call and in the function is on a whitelist for the return call site of the function.

22. The method of claim 17, further comprising forming a shadow verification stack for each function of the functions that includes a recursive function that references an entry point.

23. The method of claim 22, further comprising adding instructions that push a shadow copy of the entry point onto a corresponding shadow verification stack immediately after an instruction that updates an entry point variable of a function of the functions and pops the shadow copy of the entry point off the stack for shadow verification immediately before the function is called.

24. The method of claim 17, further comprising pruning the whitelist including a reduction of a whitelist based on an entry point of a function of the plurality of functions at runtime.
